(19) United States
(12) Patent Application Publication
(10) Pub. No.: US 2025/0028596 A1
(43) Pub. Date: Jan. 23, 2025

(54) EEPROM Correction Method

(71) Applicant: Honeywell International Inc., Charlotte, NC (US)

(72) Inventor: James L. TUCKER, Clearwater, FL (US)

(21) Appl. No.: 18/353,459

(22) Filed: Jul. 17, 2023

(51) Int. Cl. G06F 11/10

(52) U.S. Cl. CPC G06F 11/1044

(57) ABSTRACT

A computer readable storage medium and techniques to verify that information stored in the storage medium is accurate. Information in the storage medium is accurate when it is the same as the information written to the storage medium. In some examples, circuitry of the computer readable storage medium may be subject to charge leakage, and one or more bits of a word stored in the storage medium may decay, for example, from a logic zero to a logic one. The computer readable storage medium of this disclosure, e.g., referred to as a memory for short, may employ bitwise word redundancy, and selective bit wise code inversion to identify and correct errors in the stored information.

This invention was made with Government support under Contract No.: W58RGZ-16-D-0077 awarded by US Army. The Government has certain rights in the invention.

### TECHNICAL FIELD

The disclosure relates to integrated circuit memory, and more specifically to error detection and correction for memory circuitry.

### BACKGROUND

Error correction is used in computer and communication systems to improve resiliency to bit flips, which may be caused by hardware faults or transient conditions, such as cosmic rays. A computer may use random-access memory (RAM) to store data, which in some examples are stored in microscopic capacitors. Electrical or magnetic interference can cause spontaneous bit-flips in these capacitors, resulting in undesirable error. This interference is rare but can cause consequences. An example of error correction includes error correcting codes (ECCs). ECCs work by adding additional redundant bits to be stored or transported with data. The bits are encoded as a function of the data in such a way that it is possible to detect erroneous bit flips and to correct them. The ratio of the number of data bits to the total number of bits encoded is called the code rate. To determine whether there is an error processing circuitry may calculate the syndrome based on the additional redundant bits, which may also be referred to as syndrome bits.

### SUMMARY

In general, the disclosure describes a computer readable storage medium and techniques to verify that information stored in the storage medium is accurate. Information in the storage medium is accurate when it is the same as the information written to the storage medium. In some examples, circuitry of the computer readable storage medium may be subject to charge leakage, and one or more bits of a word stored in the storage medium may decay, for example, from a logic zero to a logic one. The computer readable storage medium of this disclosure, e.g., referred to as a memory for short, may employ bitwise word redundancy, and selective bit wise code inversion to identify and correct errors in the stored information.

An interface for the memory accepts a word of information to be written to the memory. The memory interface may check the bit density, e.g., counts number of ones and zeros, and determines whether to invert the word. The memory interface may perform a word inversion based on the bit density and insert word inversion marker. The memory interface may further perform an error correction calculation, append any associated syndrome bits to the result, and write the result to two parallel words stored in two parallel locations in the memory circuitry. When the memory interface retrieves a word, the memory interface may read both parallel words, compare the parallel words to determine uncorrelated errors, then use the syndrome to correct the word if needed. Finally the memory use the inversion indicator to determine whether the data is to be flipped and make the retrieved word available for use.

In one example, this disclosure describes a device comprising functional circuitry; and memory circuitry coupled to the functional circuitry, the memory circuitry configured to: store words of information received from the functional circuitry; receive a word for storage from the functional circuitry; determine a bit density for the received word; in response to the bit density satisfying a bit density threshold, perform an invert function on the word; duplicate the word into a first word and a second word; and write the first word to a first location and the second word to a second location.

In another example, this disclosure describes a method comprising receiving, by memory circuitry, a word of information for storage; determining a bit density for the word, wherein the bit density comprises a count of ones and zeros in the word; in response to the bit density satisfying a bit density threshold, performing an invert function on the word, wherein the invert function comprises changing a one into a zero and a zero into a one; after determining duplicating the word into a first word and a second word; and writing the first word to a first location and the second word to a second location of the memory circuitry.

In another example, this disclosure describes a system comprising a device that includes: functional circuitry; and memory circuitry coupled to the functional circuitry and configured to: store words of information received from the functional circuitry; receive a word for storage from the functional circuitry; determine a bit density for the received word; in response to the bit density satisfying a bit density threshold, perform an invert function on the word; duplicate the word into a first word and a second word; and write the first word to a first location and the second word to a second location.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system configured to implement information verification techniques of this disclosure.

FIG. 2 is a flow chart illustrating an example mode of operation of the memory of this disclosure.

FIG. 3 is a flowchart illustrating an example operation of the retrieve function of the memory of this disclosure.

### DETAILED DESCRIPTION

A memory may be configured to accept a word of information to be written to the memory. The memory interface may check the bit density, e.g., count a number of ones and zeros, and determine whether to invert the word. The memory interface may perform a word inversion based on the bit density and insert a word inversion marker. The memory interface may further perform an error correction calculation, append any associated syndrome bits to the result, and write the result to two parallel words stored in two parallel locations in the memory circuitry. When the memory interface retrieves a word, the memory interface may read both parallel words, compare the parallel words to determine uncorrelated errors, and then use the syndrome to correct the word if needed. Finally, the memory may use the inversion indicator to determine whether the data is to be flipped and make the retrieved word available for use.

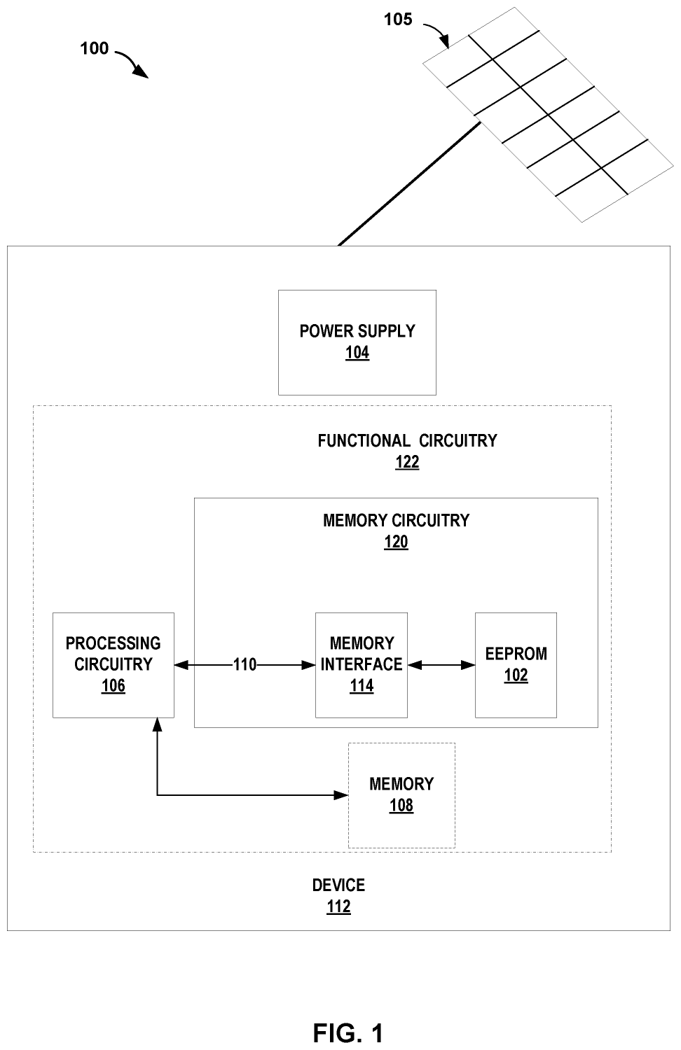

FIG. 1 is a block diagram illustrating an example system configured to implement information verification techniques of this disclosure. The example of system 100 in FIG. 1 is just one possible example arrangement of components configured to store and retrieve information according to one or more techniques of this disclosure. Other example systems may have more or fewer components than shown in system 100 and device 112. In other examples, component functions may be combined or separate in a different arrangement than shown in system 100. For example, interface 114 may be a separate component as shown, or may be integrated with the electrically erasable programmable read-only memory, EEPROM 102. Applications of device 112 may include sensing and control functions in systems such as spaceborne vehicles, such as orbiting satellites and exploratory spacecraft, as well as aircraft, ground vehicles, watercraft, processing and power plant systems, and a variety of other system applications.

In the example of FIG. 1, memory circuitry 120 includes EEPROM 102 and memory interface 114, also referred to in this disclosure as interface 114 and data bus 110. Functional circuitry 122 in FIG. 1 includes memory circuitry 120, processing circuitry 106 and memory 108. In some examples, device 112 may be implemented as an integrated circuit, such as an application specific integrated circuit (ASIC), which may include analog and digital circuitry. In other examples, device 112 may be implemented as two or more integrated circuits within system 100.

In some examples, interface 114 may include processing circuitry, logic circuitry, amplifier circuits and other circuits to read digital words from EEPROM 102, write digital words of information to EEPROM 102 for storage and perform the error correction techniques of this disclosure. In other examples, some of the functions, e.g., read, write, error correction, may be distributed between processing circuitry 106, interface 114 and EEPROM 102.

In the example of FIG. 1, processing circuitry 106 may be operatively coupled to EEPROM 102 through interface 114. Processing circuitry may also receive signals from and control the operation of other components of system 100, which may include sensors, actuators, machines, including micro-electromechanical systems (MEMS), and any number of other components (not shown in FIG. 1). Device 112 may include all of processing circuitry 106, data bus 110, interface 114, EEPROM 102, and power supply 104. Power supply 104 may store and provide power to the components of device 112. In some examples, power supply 104 may also receive electrical energy from an external power source such as solar panels 105.

Examples of processing circuitry 106, and device 112, may include any one or more of a microcontroller (MCU), e.g. a computer on a single integrated circuit containing a processor core, memory, and programmable input/output peripherals, a microprocessor (μP), e.g. a central processing unit (CPU) on a single integrated circuit (IC), a controller, a digital signal processor (DSP), an ASIC, a field-programmable gate array (FPGA), a system on chip (SoC) or equivalent discrete or integrated logic circuitry. A processor may be integrated circuitry, i.e., integrated processing circuitry, and that the integrated processing circuitry may be realized as fixed hardware processing circuitry, programmable processing circuitry and/or a combination of both fixed and programmable processing circuitry. Accordingly, the terms “processing circuitry,” “processor” or “controller,” as used herein, may refer to any one or more of the foregoing structures or any other structure operable to perform techniques described herein.

In some examples, processing circuitry 106 may be operatively coupled to memory 108. In other examples, memory 108 may be integrated with processing circuitry 106. In other examples system 100 may not include memory 108 and only use EEPROM 102 as memory. Examples of memory 108 may include any type of computer-readable storage media, which may include random access memory (RAM), read only memory (ROM), programmable read only memory (PROM), erasable programmable read only memory (EPROM), one-time programmable (OTP) memory, electronically erasable programmable read only memory (EEPROM), flash memory, or another type of volatile or non-volatile memory device. In some examples the computer readable storage media may store instructions that cause the processing circuitry to execute the functions described herein. In some examples, the computer readable storage media may the words of information, which may include data, such as configuration information, temporary values and other types of data used to perform the functions of this disclosure.

EEPROM 102 is a user-modifiable read only memory. EEPROM 102 may be erased and reprogrammed (written to) repeatedly by applying an electrical voltage that is above a specified voltage threshold for the EEPROM. In some examples, EEPROM can be erased and programmed electrically. EEPROM may have a limited life span of 10,000 or more write cycles. In some examples, EEPROM 102 may have an architecture that may allow electrons injected into the floating gate to drift through the insulator, which may not be a perfect insulator. In some examples, some charge may be lost, which could result in some data getting erased and portions of the memory cell reverting to an erased state. In some examples, environmental factors, such as temperature, exposure to radiation and other factors may also affect the data retention time in EEPROM.

In the example of FIG. 1, EEPROM 102 may store information in the form of capacitive of charge on an isolated node, e.g., to store a bit. To write a logic LOW the circuitry, e.g., interface 114, may introduce a charge. To write a logic HIGH the circuitry may remove charge on the node (not shown in FIG. 1). To read the bit, interface 114 may measure the charge residing on the isolated node and generates the complement of the stored charge. Therefore, a logic ZERO is decoded when charge is HIGH, and logic ONE is decoded when the charge is LOW. As described above, some subset of the bits for EEPROM 102 may exhibit a loss of charge over time.

In some examples, the loss of charge may be caused by a mechanism for charge leakage in dielectric layer of the EEPROM cell. An EEPROM cell, or memory cell may also be referred to as a node in this disclosure. In some examples the mechanism for charge leakage may be a result of a manufacturing defect, or some similar cause. In some examples the failure rate of may be as high as up to one failure in forty cells (1/40). In some examples, a memory cell may have larger capacitive structures in some areas, which may result that larger area may result in a higher incidence of memory cell defects. The cause may be that the larger capacitive structures may provide greater opportunity for leakage. In some examples, some industry best practices have demonstrated the ability to use elevated temperature on charged EEPROM bits, which may help repair cell function.

In the example of EEPROM 102 it is only possible for a memory cell to fail in one direction. That is, a memory cell circuit of EEPROM 102 suffers only from a charge leakage failure but not from a charge accumulation failure. In this disclosure, a memory cell may also be referred to as a node or memory node. Each memory cell may be associated with a bit of a digital word.

For example, in normal operation a HIGH charge on an internal node of EEPROM 102 may store a logic ZERO. Therefore, a HIGH charge on the internal node will yield a logic ZERO output during a read from the cell, while no charge, e.g., a LOW, on the internal node will result in a logic ONE during a read. What this means is that upon a read if processing circuitry 106 gets a logic ONE, then the logic ONE could have resulted from two conditions. First, either the node was set HIGH and then went LOW caused by an error condition, or second, the node was set LOW to start with. If however, processing circuitry 106 reads a logic ZERO, it means exclusively that the node was set HIGH and remains HIGH. The processing circuitry of this disclosure may therefore be configured to determine that upon reading an EEPROM bit, processing circuitry 106 may always trust a logic ZERO (a HIGH charge) but always doubt the logic ONE (a LOW charge). In other words, EEPROM 102 may be subject to a one-sided error condition.

The circuitry of this disclosure may exploit this one-sided error condition, by employing both (a) simply redundancy and (b) code inversion to reduce the probability that EEPROM 102 may have an uncorrectable number of errors in a single word. The circuitry of this disclosure may further manipulate the error distribution so that the probabilities will work within the single word making the reliability of the EEPROM array less dependent on the overall array size. In some examples, the error correction approach of this disclosure may be divided into a two-step process: (1) word redundancy and (2) word inversion during writes to minimize ones (LOW charge).

Moreover, for circuitry in which errors only happen in one direction, then for a given N bit word, inverting the word may reduce the probability of error in examples in which inverting the data words would reduce the number of possible error states to <N/2. Example for an 8 bit word where 1s fail to 0s, then FF (0x1111 1111) would have a possibility of 8 errored bits, F0 (0x1111 0000 would have a possibility of 4 errored bits, FB (0x1111 1100) would have a possibility of 6 errored bits unless we invert it and store it as 03 (0x0000 0011) reducing the possibility to 2 errored bits.

In some examples, for the word redundancy the circuitry of this disclosure, e.g., processing circuitry 106, interface 114 and or EEPROM 102, may replicate the entire word, including the syndrome, to create a redundant pair of encoded words. In this disclosure, the syndrome may be a series of bits concatenated onto the word, for example, at the end of the word. The circuitry may calculate the syndrome based on any number of different techniques, e.g., multiplying the word by a parity check matrix, or by some other techniques. During a read, the pattern of errors, called the error syndrome, may identify the bit in error. If all the syndrome, aka parity, bits are correct, there is no error. Otherwise, the positions of the erroneous parity bits may identify the erroneous bit in the stored word.

The word redundancy step will be illustrated by the following example. For this example, the redundant word pairs will be referred to as Word A and Word B. The same information would be written to each. The replication will provide spatial diversity of the bits, to exploit the fact that there will be a decreased probability that if errors occur in both, that they will occur in the same bit position of each member of the pair. In some examples, the manufacturing defects, which may be responsible for the charge loss mechanism, may have independent defect distributions for a given pair of bits since they will be on physically on different parts of the chip.

As discussed above, errors are not present with logic ZERO (a HIGH charge) and possibly present with logic ONE (a LOW charge), then the circuitry of this disclosure may perform a simple bitwise AND Boolean function between the redundant pair of encoded words A and B to eliminate uncorrelated errors between words. Uncorrelated errors meaning errors that do not affect the same bit of the pair. Correlated errors that affect the same bit of each word are still possible, but, as noted above, correlated errors can only ever take the form of a logic ONE.

The example in the table below shows Word A and Word B as six-bit words with three error correction code (ECC) syndrome bits for each word. The errors highlighted in cells with italicized ONEs. The techniques of this disclosure may make it easy to detect multiple errors because ZEROS are always trusted. A possible correlated error with logic level ONE is highlighted in bold italics. For the possible correlated bit error, it is probable that the result is ONE, but there is still the possibility that the ONE in each word could be caused by a correlated error in the same bit position in both Word A and Word B. But with both the word redundancy and the fact that a logic ZERO (HIGH charge) is trusted, probability is working in favor, and as the example below depicts, may eliminate all the uncorrelated errors. Because Word A and Word B include syndrome bits, the ability for the circuitry reading the stored data word to correct remaining errors may be greatly enhanced, when compared to other EEPROMs that operate in a manner different than EEPROM 102 of this disclosure.

TABLE 1
Example of Word Redundancy with Bitwise AND Combination

| | ECC Syndrome | | | Data Word | | | | | |
|---|---|---|---|---|---|---|---|---|---|
| Word A | 1 | 0 | 1 | 0 | 1 | 1 | 0 | 0 | 0 |
| Word B | 0 | 1 | 0 | 0 | 0 | 1 | 0 | 1 | 0 |
| AND | 0 | 0 | 0 | 0 | 0 | 1 | 0 | 0 | 0 |

For a second step, the circuitry of this disclosure may selectively invert both of the data words, and their syndrome bits, before writing the words to the respective storage location in EEPROM 102, depending on the bit count for the word. In other words, to further improve error rejection and correction capability, the circuitry of this disclosure may employ additional steps to further reduce the probability for errors. In some examples, a second step may include of inverting each word A and B of the word pair during the write based on the ones-density of the word. In this disclosure the ones-density may also be referred to as a bit density. For example, a word 0x7F would provide seven error opportunity locations, e.g., seven bits of logic ONE. However, a word 0x80 would provide only one error location, e.g., a single bit of logic ONE and the remainder of logic ZERO (LOW charge).

By selectively inverting each word of the word pair, this example second step of this approach may confine the worst-case error condition to the case where the data word has half bits at logic ONE and half the bits at logic ZERO. What this means is that the number of bits where errors can occur may be cut in half. Thus a worst-case error condition would be for a word like 0x0F because both the word and its inverse 0xF0 both have the same opportunity error. So then by flipping the word during a write then un-flipping during a read the circuitry of this disclosure may deliver data patterns that reduce the opportunity for error (minimize logic ONE) while the data is stored in EEPROM.

In other examples, the circuitry of this disclosure may invert the second word of the pair of stored data words. In some examples, the circuitry of this disclosure may invert the second data word rather than selectively inverting both data words. In other examples, the circuitry may execute the step of inverting the second word after performing all the steps listed above. In this manner by storing the bits inverted, the circuitry may recover the correct value every time because each pair of bits will have at least one bit that is in the charged state. Because bits only fail in one direction, the circuitry may always have the ability to recover the correct value.

In some examples, a stored data word may include a data flip indicator, e.g., one or more bits appended to the data word to indicate the word has been inverted. In the example of appending a bit to the stored data word, the data flip indicator should also be protected by error correction. Not also that error correcting codes in the syndrome bits may also constrain the one zero balance on any word. Thus, in some examples, the circuitry of this disclosure may also flip part of the word in some examples, rather than the entire word. In other words, in response to the bit density satisfying a bit density threshold, invert only a first portion of the word and refrain from inverting a second portion of the word.

The techniques of this disclosure may have advantages over other bit error detection and correction procedures. In terms of probability, alternative error correction procedures may provide a pessimistic outlook if error rates are as high as one error per forty bits (1/40). To improve the single bit correction on a forty-bit word, e.g., to increase the margin may mean to assume baseline of two bits error correction on a forty-bit word. One weakness of this approach of increasing the margin is that the approach assumes that the error distribution would limit the occurrence of errors to one or two errors per word, respectively. However greater than 2-bit errors are conceivable within any 40-bit word. To add more correction, may require more syndrome bits to be appended to the word. But unfortunately since syndrome bits can also be in error, adding more bits also adds the opportunity for more error, and so as the syndrome grows, so does the size of the EERPOM and with the increased size, or reduced data storage capacity, the increased error problem. In addition, the larger syndrome algorithms add complexity and require more clock cycles for the processing circuitry, e.g., processing circuitry 106 and/or interface 114, and may negatively impact design performance. In this scenario the EEPROM array overhead grows significantly, along with the complexity of the error correcting codes.

In contrast, the techniques of this disclosure may relax the severity of the traditional error correction schemes to more reasonable levels. Said another way, by operating EEPROM 102 with the one-sided error condition, applying word redundancy and selective bit inversion, means that an EEPROM according to this disclosure may reliably operate with a reduced number of syndrome bits per data word, reduced complexity, and a smaller size EEPROM with larger storage capacity when compared to other data bit error correction techniques.

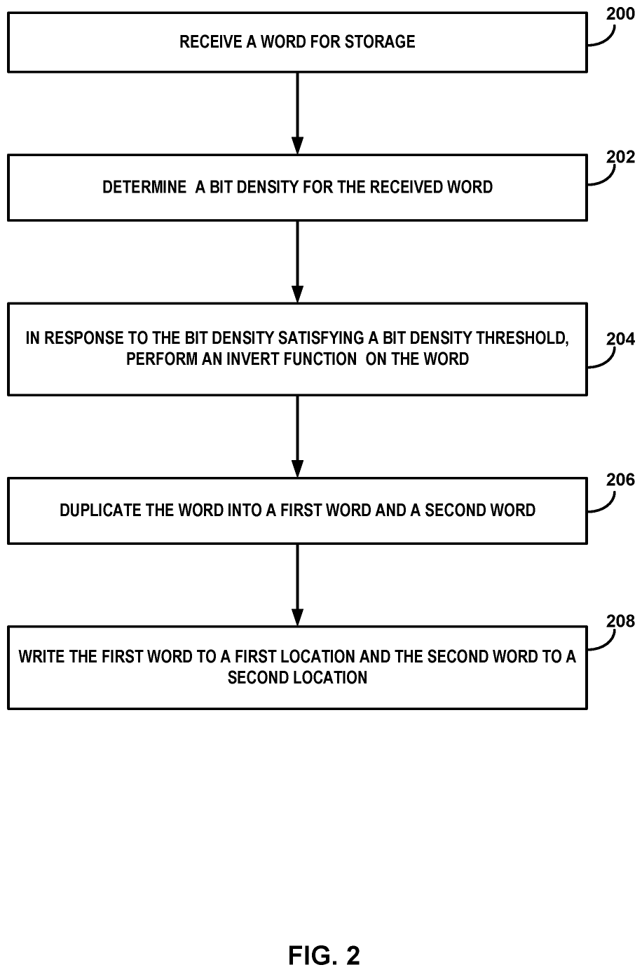

FIG. 2 is a flow chart illustrating an example mode of operation of the memory of this disclosure. As described above in relation to FIG. 1, any circuitry of system 100 may perform the functions described in this disclosure. In some examples, memory interface 114 may accept a word to be written to EEPROM 102. Memory interface 114 may count the number of logic ONEs in the received word and determine whether to invert the word, or some portion of the word. Circuitry of system 100, e.g., interface 114 may invert the received word and insert a word inversion marker as needed. In some examples, the circuitry may calculate the syndrome over the result and write the result to two parallel locations in EEPROM 102.

To retrieve data or instructions stored at EEPROM 102, memory interface 114 may retrieve a word from EEPROM 102 by reading both parallel words. Memory interface 114 may combines the parallel words, e.g., with an AND function, use the syndrome to correct the word and then uses the inversion indicator to determine whether the data word is to be flipped.

To simplify the description of FIG. 2, the disclosure may indicate that the “memory” is performing the functions. This wording is intended to describe that, for example EEPROM 102, interface 114, or some other component of system 100 may perform all or part of the receiving, storing, inverting, EEC calculating and other functions described herein.

As described above in relation to FIG. 1, a memory, e.g., EEPROM 102 may be configured to store words of information comprising digital bits. EEPROM 102 may receive a word for storage (200), e.g., via processing circuitry 106, interface 114, or other functional circuitry.

The memory may determine a bit density for the received word, e.g., count the number of digital ONEs and/or digital ZEROs in the received word (202). In response to the bit density meeting a specified criteria, e.g., satisfying a bit density threshold, the memory may perform an invert function on the word (204). As described above in relation to FIG. 1, storing a representation of the received word that has more digital ZEROs (a HIGH charge) may improve the probability of accurately retrieving the stored word later. Thus the memory may determine that a received word that has a majority of digital ONEs, e.g., a bit density, aka a ones-density, greater than, for example, a threshold of fifty percent may be best stored inverted.

The memory may duplicate the word into a first word and a second word (206), and write the first word to a first location and the second word to a second location (208). In some examples, the memory may also calculate an ECC for the received word; and append the ECC syndrome bits to the received word. In some examples, as described above in relation to FIG. 1, the memory may invert the second word before writing the second word to the second location. In some examples, to receive and store the word, interface 114, or circuitry of EEPROM 102 may increase a voltage to electrically erase a location of EEPROM 102 and write the received word.

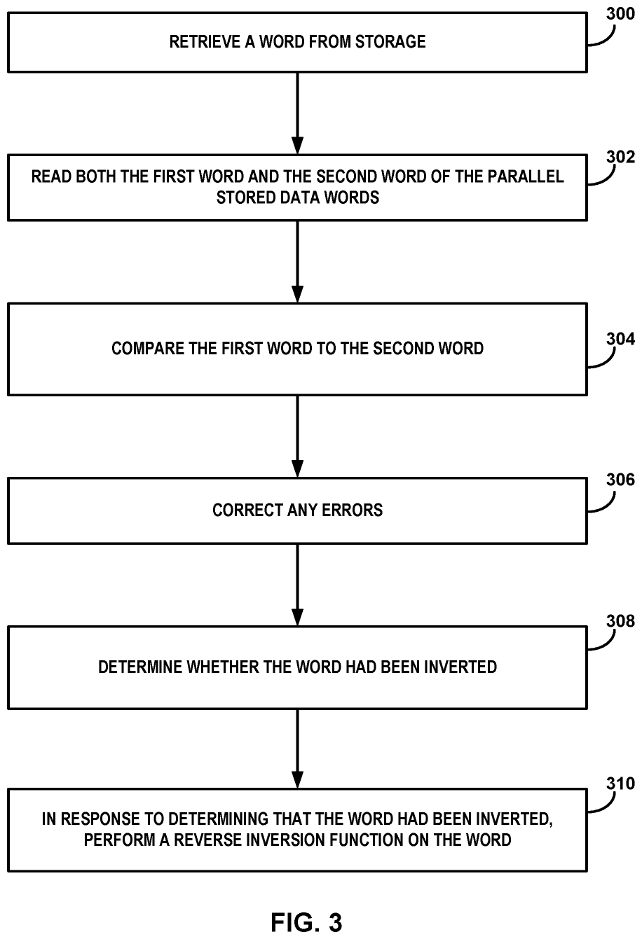

FIG. 3 is a flow chart illustrating an example operation of the retrieve function of the memory of this disclosure. As described above in relation to FIG. 1, to retrieve data or instructions stored at EEPROM 102, memory interface 114 may retrieve a word from EEPROM 102 by reading both parallel words. Memory interface 114 may combines the parallel words, e.g., with an AND function, use the syndrome to correct the word and then uses the inversion indicator to determine whether the data word is to be flipped.

In other words, the memory may read the word, e.g., based on a request for the data, or programming instructions from, for example, processing circuitry 106 depicted in FIG. 1. The memory may retrieve the word from storage (300), which may include reading both the first word and the second word of the parallel stored data words (302).

The memory may compare the first word to the second word (304), which in some examples may include a Boolean AND function of the first word with the second word. As described above, each of the stored words may include syndrome bits, inversion indicators and other bits.

The memory may further correct any uncorrelated errors, e.g., based on the results of the comparison (306). The memory may further correct correlated errors, if any, based on the syndrome bits, if applicable.

The memory may check any inversion indicator for the retrieved words and determine whether the word had been inverted (308). In response to determining that the word had been inverted, perform a reverse inversion function on the word (310). In some examples, memory may perform the reverse inversion step before the comparison step. In other examples, the memory may compare the retrieved words before checking for an inversion.

In some examples, the memory may determine whether to perform an inversion step on only the second stored word. As described above in relation to FIG. 1, if only the bits of the second word are inverted in relation to the first parallel word, the circuitry may recover the correct value because each pair of bits will have at least one bit that is in the charged state. Because bits only fail in one direction, the circuitry may recover the correct value.

As described above in relation to FIG. 1, the techniques of this disclosure may have the benefits of employing bitwise word redundancy, and selective bit wise code inversion. The storage and retrieval process may be applied to reject more uncorrelated errors than is practical with traditional methods, and the approach of this disclosure may amplify the effectiveness of less severe error correcting codes on the remaining errors by reducing the quantity of errors in general. In this manner, the techniques of this disclosure may help limit the overhead of error correcting, and other non-data bits to, for example, twice the length of the data bits alone. In addition, the error correction techniques of this disclosure may use less advanced and less complex error correction codes compared to other procedures. In this manner, though there may still be cases where uncorrectable errors are possible, the probability of those effects occurring may be greatly diminished compared to other procedures, and may result in better predictability of the system behavior.

The techniques of this disclosure may also be described in the following examples.

Example 1: A device comprising functional circuitry; and memory circuitry coupled to the functional circuitry and configured to: store words of information received from the functional circuitry; receive a word for storage from the functional circuitry; determine a bit density for the received word; in response to the bit density satisfying a bit density threshold, perform an invert function on the word; duplicate the word into a first word and a second word; and write the first word to a first location and the second word to a second location.

Example 2: The device of example 1, wherein the memory circuitry is further configured to: calculate an error correcting code (ECC) for the received word; and append the ECC to the received word.

Example 3: The device of examples 1 and 2, wherein the memory circuitry is configured to determine the bit density for the received word after appending the ECC to the received word.

Example 4: The device of any of examples 1 through 3, wherein the first location is at a first area of circuitry for the memory circuitry and the second location is at a second area of circuitry for the memory circuitry separate from the first area.

Example 5: The device of any of examples 1 through 4, wherein the memory circuitry is configured to read the word, wherein to read the word comprises: compare the first word to the second word; correct any uncorrelated errors; determine whether the word had been inverted; in response to determining that the word had been inverted, perform a reverse inversion function on the word.

Example 6: The device of example 5, wherein to compare the first word to the second word comprises a bitwise comparison of the first word to the second word.

Example 7: The device of example 6, wherein the bitwise comparison comprises an AND logic function.

Example 8: The device of any of examples 1 through 7, wherein the memory circuitry is further configured to invert the second word before writing the second word to the second location.

Example 9: The device of any of examples 1 through 8, wherein the invert function comprises to invert a first portion of the word and refrain from inverting a second portion of the word.

Example 10: The device of any of examples 1 through 9, wherein the memory circuitry comprises: interface circuitry configured to receive the words from the functional circuitry; a plurality of cells to store bits representing the words.

Example 11: A method comprising receiving, by memory circuitry, a word of information for storage; determining a bit density for the word, wherein the bit density comprises a count of ones and zeros in the word; in response to the bit density satisfying a bit density threshold, performing an invert function on the word, wherein the invert function comprises changing a one into a zero and a zero into a one; after determining duplicating the word into a first word and a second word; and writing the first word to a first location and the second word to a second location of the memory circuitry.

Example 12: The method of example 11, further comprising reading both the first word and the second word; comparing the first word to the second word; correcting any errors in the word based on the comparison; determining whether the word had been inverted when stored; in response to determining that the word had been inverted, perform a reverse inversion function on the word; output the word.

Example 13: The method of example 12, wherein comparing the first word to the second word comprises combining the first word and the second word with a logical AND function.

Example 14: The method of any of examples 11 through 13, further comprising; calculating an error correcting code (ECC) for the received word; and appending the ECC to the received word.

Example 15: The method of example 14, wherein determining the bit density for the word comprises determining the bit density after appending the ECC to the received word.

Example 16: The method of any of examples 11 through 15, wherein the first location is at a first area of circuitry for the memory circuitry and the second location is at a second area of circuitry for the memory circuitry separate from the first area.

Example 17: The method of any of examples 11 through 16, wherein the invert function comprising inverting a first portion of the word and refrain from inverting a second portion of the word.

Example 18: The method of any of examples 11 through 17, further comprising after duplicating the word into the first word and the second word, inverting the second word before writing the second word to the second location.

Example 19: A system comprising a device that includes: functional circuitry; and memory circuitry coupled to the functional circuitry and configured to: store words of information received from the functional circuitry; receive a word for storage from the functional circuitry; determine a bit density for the received word; in response to the bit density satisfying a bit density threshold, perform an invert function on the word; duplicate the word into a first word and a second word; and write the first word to a first location and the second word to a second location.

Example 20: The system of example 19, wherein the memory circuitry is configured to read the word, wherein to read the word comprises: compare the first word to the second word; correct any uncorrelated errors; determine whether the word had been inverted; in response to determining that the word had been inverted, perform a reverse inversion function on the word.

In one or more examples, the functions described above may be implemented in hardware, software, firmware, or any combination thereof. For example, the various components of FIG. 1, such as EEPROM 102, processing circuitry 106 and interface 114 may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

The term “non-transitory” may indicate that the storage medium is not embodied in a carrier wave or a propagated signal. In certain examples, a non-transitory storage medium may store data that can, over time, change (e.g., in RAM or cache). By way of example, and not limitation, such computer-readable storage media, may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” and “processing circuitry,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

What is claimed is:

1. A device comprising:
functional circuitry; and
memory circuitry coupled to the functional circuitry, the memory circuitry configured to:
store words of information received from the functional circuitry;
receive a word for storage from the functional circuitry;
determine a bit density for the received word;
in response to the bit density satisfying a bit density threshold, perform an invert function on the word;
duplicate the word into a first word and a second word; and
write the first word to a first location and the second word to a second location.

2. The device of claim 1, wherein the memory circuitry is further configured to:
calculate an error correcting code (ECC) for the received word; and
append the ECC to the received word.

3. The device of claim 2, wherein the memory circuitry is configured to determine the bit density for the received word after appending the ECC to the received word.

4. The device of claim 1, wherein the first location is at a first area of circuitry for the memory circuitry and the second location is at a second area of circuitry for the memory circuitry separate from the first area.

5. The device of claim 1, wherein the memory circuitry is configured to read the word, wherein to read the word comprises:
compare the first word to the second word;
correct any uncorrelated errors;
determine whether the word had been inverted;
in response to determining that the word had been inverted, perform a reverse inversion function on the word.

6. The device of claim 5, wherein to compare the first word to the second word comprises a bitwise comparison of the first word to the second word.

7. The device of claim 6, wherein the bitwise comparison comprises an AND logic function.

8. The device of claim 1, wherein the memory circuitry is further configured to invert the second word before writing the second word to the second location.

9. The device of claim 1, wherein the invert function comprises to invert a first portion of the word and refrain from inverting a second portion of the word.

10. The device of claim 1, wherein the memory circuitry comprises:
interface circuitry configured to receive the words from the functional circuitry;
a plurality of cells to store bits representing the words.

11. A method comprising:
receiving, by memory circuitry, a word of information for storage;
determining a bit density for the word, wherein the bit density comprises a count of ones and zeros in the word;
in response to the bit density satisfying a bit density threshold, performing an invert function on the word, wherein the invert function comprises changing a one into a zero and a zero into a one;
after determining duplicating the word into a first word and a second word; and
writing the first word to a first location and the second word to a second location of the memory circuitry.

12. The method of claim 11, further comprising retrieving, by the memory circuitry, the word from storage, wherein retrieving the word comprises:
reading both the first word and the second word;
comparing the first word to the second word;
correcting any errors in the word based on the comparison;
determining whether the word had been inverted when stored;
in response to determining that the word had been inverted, perform a reverse inversion function on the word;
output the word.

13. The method of claim 12, wherein comparing the first word to the second word comprises combining the first word and the second word with a logical AND function.

14. The method of claim 11, further comprising;
calculating an error correcting code (ECC) for the received word; and
appending the ECC to the received word.

15. The method of claim 14, wherein determining the bit density for the word comprises determining the bit density after appending the ECC to the received word.

16. The method of claim 11, wherein the first location is at a first area of circuitry for the memory circuitry and the second location is at a second area of circuitry for the memory circuitry separate from the first area.

17. The method of claim 11, wherein the invert function comprising inverting a first portion of the word and refrain from inverting a second portion of the word.

18. The method of claim 11, further comprising: after duplicating the word into the first word and the second word, inverting the second word before writing the second word to the second location.

19. A system comprising:
a device that includes:
functional circuitry; and
memory circuitry coupled to the functional circuitry and configured to:
store words of information received from the functional circuitry;
receive a word for storage from the functional circuitry;
determine a bit density for the received word;
in response to the bit density satisfying a bit density threshold, perform an invert function on the word;
duplicate the word into a first word and a second word; and
write the first word to a first location and the second word to a second location.

20. The system of claim 19, wherein the memory circuitry is configured to read the word, wherein to read the word comprises:
compare the first word to the second word;
correct any uncorrelated errors;
determine whether the word had been inverted;
in response to determining that the word had been inverted, perform a reverse inversion function on the word.
